(19) United States
(12) Patent Application Publication
(10) Pub. No.: US 2014/0267817 A1
(43) Pub. Date: Sep. 18, 2014

(54) SYSTEMS AND METHODS OF ATTRACTING ATTENTION IN PHOTOGRAPHY OR VIDEOGRAPHY

(71) Applicants: Ales Zerovec, Ljubljana (SI); Saso Filipcic, Ljubljana (SI)

(72) Inventors: Ales Zerovec, Ljubljana (SI); Saso Filipcic, Ljubljana (SI)

(21) Appl. No.: 13/826,548

(22) Filed: Mar. 14, 2013

(51) Int. Cl. H04N 5/225

(52) U.S. Cl. CPC H04N 5/225
USPC 348/220.1

(57) ABSTRACT

A method of attracting attention to a camera includes playing audio-visual content from a portable multi-function device having a housing having a first major side facing in a first direction and a second major side facing in a second direction different from the first direction, the housing supporting a screen facing in the first direction and a camera facing the first direction; and causing operation of the camera to capture at least one of a photograph and movie while the audio-visual content is played. Other systems and methods are provided.

### TECHNICAL FIELD

The technical field comprises photography. The technical field also comprises digital imaging devices including still and video cameras. The technical field also comprises portable multifunction devices containing cameras and screens.

### BACKGROUND

When taking a picture or video of humans or animals, it is desirable to attract the attention of the subject of the picture or video. If the subject does not look at the imaging device, the photograph or video may not be as compelling as when the subject does look at the imaging device. It is often desirable for a subject to have eye contact with a camera lens. Attracting the attention of children or elderly can be a challenge, as anyone who has been involved in the shooting of a family photograph can attest.

There have been many and varied attempts to address this issue. For example, U.S. Pat. No. 5,991,547 to Baiera et al. (incorporated herein by references) discloses an attention attracting article for a viewing device, such as a camera or a pair of binoculars cut from a single sheet of cardboard and folded around the viewing device, including a character with a head extending out and with hands.

U.S. Patent Application Publication 2007/0172223 to Eberhardt (incorporated herein by reference) discloses an attention-getting camera attachment that connects to a connector of a camera or tripod, and that includes an ornament for garnering attention of a subject being photographed. The ornament may incorporate light, color, sounds, motion, chemical, odor, or other techniques for attracting attention.

U.S. Pat. No. 7,990,435 to Jelinek (incorporated herein by reference) discloses a digital imaging device that may include the capability to store audio files. The audio files may be played back as attention grabbers to attract the attention of the imaging subjects.

U.S. Pat. No. 7,941,046 to Parnell discloses a camera accessory to attract the attention line-of-sight of an infant toward the camera. A truncated pyramidal-shaped structure is provided having panes or panels each having an isosceles trapezoidal shape. The panels have forward faces comprising a pattern with a high-contract color schema.

These references illustrate the long-felt need for a solution to the problem of attracting the attention of imaging subjects.

### SUMMARY

Some embodiments provide a method of attracting attention to a camera, the method including playing audio-visual content from a portable multi-function device having a housing having a first major side facing in a first direction and a second major side facing in a second direction different from the first direction, having a screen supported by the housing, the screen facing in the first direction, and the device having a camera facing the first direction; and causing operation of the camera to capture at least one of a photograph and movie while the audio-visual content is playing.

Some embodiments provide a computer readable medium bearing computer program code which, when executed by a portable multi-function device having a housing having a first major side facing in a first direction and a second major side facing in a second direction different from the first direction, having a screen supported by the housing and facing in the first direction, having a speaker, and having a camera facing the first direction, causes the device to play audio-visual content using the screen and the speaker, and operate the camera to capture at least one of a photograph and movie, while the audio-visual content is played.

Some embodiments provide a portable multi-function device including a housing having a first major side facing in a first direction and a second major side facing in a second direction different from the first direction; a touchscreen supported by the housing and facing in the first direction; a speaker supported by the housing; a first camera supported by the housing and facing the first direction; a second camera supported by the housing and facing in the second direction; a memory; a processor coupled to the touchscreen, speaker, camera, and memory; audio-visual content in the memory configured to elicit a reaction from a subject of a photograph; an application in the memory configured to play the audio-visual content on the touchscreen and to capture a photograph, using the first camera, during playing of the audio-visual content.

### BRIEF DESCRIPTION OF THE VIEWS OF THE DRAWINGS

FIG. 1 is a block diagram of a system in accordance with various embodiments.

FIG. 2 is a perspective view illustrating operation of the system of FIG. 1 in accordance with various embodiments.

FIG. 3 is a high level flowchart illustrating operation of an application included in the system of FIG. 1 in accordance with various embodiments.

FIG. 4 is a flowchart illustrating operation of various alternative embodiments of an application included in the system of FIG. 1.

FIG. 5 is a continuation of the flowchart of FIG. 4.

### DETAILED DESCRIPTION OF THE ILLUSTRATED EMBODIMENTS

Phones and other portable devices that include cameras and screens are known in the art. These portable multifunction devices include, for example, smartphones, as well as tablet computers (e.g., iPad, Android tablet) or media players that include a camera but do not include telephone functionality (e.g., iPod touch), for example. These devices sometimes include touch screens, which may be able to recognize various gestures. Such multifunction devices are described, for example, in the following patents and patent publications, all of which are incorporated herein by reference: U.S. Pat. No. 5,666,502 to Capps; U.S. Pat. No. 7,761,414 to Freedman; U.S. Pat. No. 8,014,760 to Forstall et al.; U.S. Pat. No. 8,046,721 to Chaudhri et al.; U.S. Pat. No. 8,074,172 to Kocienda et al.; 2006/0026521 by Hotelling et al.; and 2008/0088602 by Hotelling.

FIG. 1 shows a portable multifunction device 10 in accordance with various embodiments. The device 10 includes, for example, a processor 12 and an Input/Output controller illustrated, for simplicity, in the block 12.

The device 10 may further include one or more hardware buttons or switches 14, 16, 18, 20 and 22 such as a switch 14 to increase audio volume or ringer volume, a switch 16 to decrease audio volume or ringer volume, a switch 18 to switch ringer modes (e.g., from ring to vibrate), a power switch 20, and a home button 22 (e.g., return to main screen). One or more of these hardware buttons can be replaced with soft buttons (e.g., areas on a touchscreen) in various embodiments. The buttons may be dedicated to specific functions, may control different functions in different situations, or may control functions that are assigned by a user.

The device 10 in various embodiments includes one or more microphones 24 such as for use as the mouthpiece in a telephone call, for speakerphone use, for background noise cancellation, for recording sound, or for other sound capture applications.

The device 10 in various embodiments further includes one or more speakers 26 such as for use as the earpiece in a telephone call, for speakerphone use, for playing music, or for other audio playing applications. At least one speaker and one microphone are appropriately spaced apart for use as a telephone, in various embodiments.

The device 10 may include one or more jacks or connectors 28 and 30 such as a speaker or speaker and microphone jack 28 and a computer interface connector 30. The computer interface connector 30, in various embodiments, allows data transfer to a computer.

The device 10 in various embodiments further includes a battery 32 and charging circuitry 34.

In some embodiments, battery charging is performed via the computer interface connector 30, such as when it connects to a USB port of a computer. In some embodiments, the connector 30 can be used for battery charging without data transfer, such as when it is coupled to a power connector such as an AC transformer, via a cable. In some embodiments, the connector 30 allows docking to a docking station or table radio, for charging, or data transfer, or both.

The device 10 further includes a screen 36 which, in various embodiments, is a touchscreen. The screen 36 can include soft buttons and, in the illustrated embodiment, has reconfigurable input areas that vary depending on the situation. The screen 36 also can display text or graphics or both, in black and white or color. The screen 36, in various embodiments, is capable of recognizing gestures, such as some or all of the gestures described in the above-incorporated patents.

The device 10 may further include one or more mobile phone radio or transceivers 38 such as a CDMA, GSM, HSPA, LTE, transceiver, or any other mobile phone radio or transceiver for transferring data or making phone calls, or some combination of multiple of these. The device 10 may also include a SIM card reader 40 for receiving a SIM card containing account details of a user. The device 10 may also include one or more other radios or transceivers such as a Wi-Fi transceiver 42, a Bluetooth transceiver 44, an infrared transmitter or transceiver 46, a global positioning system receiver 48, or some combination of multiple of these. The device 10 may also further include one or more antennas 50 for one or more of these transceivers 38, 42, 44, 46, and 48.

The device 10 may further include one or more motion sensors 52 (e.g., accelerometers) for determining orientation of the device 10 or sensing position or movement of the device 10. Certain actions may occur in response to a change of position or in response to movement.

The device 10 in various embodiments further includes a rear facing camera 54 which points away from the touchscreen 36. The device 10 in various embodiments further includes a front facing camera 56 facing in at least generally the same direction as the touchscreen, such as towards the user of the touchscreen. In some embodiments, there is another touchscreen 36 on the rear of the device 10. The device 10 may further include one or more rear or front facing flashes 58 for illuminating the subject of a photo or video.

The device 10 further includes a memory 60 in communication with the processor 12. The memory 60 may include volatile memory, non-volatile memory, or both, and may also include memory from a memory card or stick. The memory 60 bears an operating system 62, such as iOS (e.g., iOS 6), an Android operating system, a Windows operating system (e.g., Windows 8), a Linux operating system, a Chrome operating system, a Firefox operating system, some variation of one of these, or another operating system. The memory 60 also contains data 64 such as music (or other audio files) 66, videos 68, presentations 70, pictures or photos 71, books 72, magazines 74, documents 76, and other data 78. The data 64 can include files containing multi-media such as the videos 68 and the magazines 74. At least some of the data 64 is used by apps 80. The apps 80 include, for example, user-downloadable programs or applications, as well as default applications that are pre-installed when the device 10 is bought. The applications comprises, for example, games, applications for reading books, for reading magazines, for reading or editing documents, for playing music, for recording audio, for playing videos, for recording videos, for playing presentations, for taking photographs, for editing photographs, for making phone calls, etc. Attention is directed to the applications available in the Apple app store, the Google Android (Play) app store, and the Amazon app store. The applications 80 installed in the device 10 of various embodiments can include multiple of such applications, indicated with reference numerals 82 and 84, as well as an attention getting application 86 described in more detail below. At least some of the data 64 is used or created by the applications 80. Also, at least some of the data 64 is used by the operating system 62.

In some embodiments, the application 82 is a camera application, for controlling the cameras 54 and 56 and flash 58, and for providing a user interface using which camera controls, programs, features, or circuitry 102 can be manipulated. The camera controls 102 include, for example, an autofocus control 104, a zoom control 106, a flash on, off and autoflash control 108, a high dynamic range control 110 (with high dynamic range on, multiple exposures of the same scene are taken and combined), a panoramic photo control 112, an autoexposure control 114, video record controls 116, a facial recognition feature 118, and a smile recognition feature 120. Other camera controls that are known to be provided in smart phones or tablets can be provided. In various embodiments, the cameras 56 and 54 can be controlled in a similar manner by apps other than the camera app 82. In other words, the camera controls can be controlled using the app 82 or using a third party application, such as the application 86. In some embodiments, the camera controls 102 can be used or manipulated using an application programming interface.

In various embodiments, the application 86 combines the function of the camera 56 (and camera controls 102) and the screen 36. In operation of some embodiments, as shown in FIGS. 2 and 3, the screen 36 or speaker(s) 26 play or shows 121 audio-visual content (e.g., a video 68, presentation 70, a picture or photo 71, or music 66) while the camera 56 on the device 10 captures 122 one or more photos or videos (movies). It should be apparent that capturing videos includes capturing multiple photos. In other embodiments, the application 86 attracts the attention of the person who is looking at the screen 36 or looking at the device 10 in response to to audio coming from a speaker 26 and takes a photo with the camera 56 at the desired moment. In some embodiments, the application 86 selectively makes movies of people looking at the device 10.

FIG. 2 also illustrates that the device 10 has a housing 90 having a front side 92 facing in a first direction and a rear side 94 facing in an opposite direction. In the illustrated embodiment, the housing 90 supports the screen 36 on the same front side 92 as the front facing camera 56. Thus, the screen 36 faces in the first direction and the camera 56 faces in the first direction.

In some embodiments, there are different target markets for the application 86. One target market includes parents who want to take good pictures of their kids while they are looking at the device 10 or smiling. The desired result can be generated based on the audio-video content that is selected to be played.

Another target market includes younger users (e.g., teenagers) or those young at heart who will want to take covert (e.g., spy) photos or movies of friends who will be looking at the desired audio-video content on their device. There are also other target groups.

In some embodiments, the application 86 is made available for other app developers to include it into their apps to take photos of reactions by users using their apps.

In some embodiments, there are different versions of the application 86. For example, a basic version 202 (which could be free or low cost) has a limited amount of audio-video content available and upgrading to a higher (e.g. “professional”) version 204 (paid or higher cost version) allows the user to download more or other attention-getting files to the device 10 (e.g., from a server provided by the vendor of the application 86) or from an app store (e.g. along with the application 86).

In some embodiments (see FIG. 4), the basic version 202 offers more limited functionality, such as it will only allow the user to take one picture every so many predetermined seconds (e.g., only one picture every three seconds) 206 while AV content is playing 208 whereas the professional version 204 allows a user to set 210 the intervals in which pictures are taken 212 while the attention-getting content is played 211.

Alternatively, or in addition, the professional version allows a user to set 214 the exact time in the audio-video content when the picture or pictures are taken (e.g., by displaying a graphical user interface showing a set of thumbnails of a video along a timeline and by receiving clicks to indicate set points at which photos will be taken). The photos are captured 216 when the set location or locations are reached in the AV content while the attention-getting content is played 215.

Alternatively, or in addition, one or both versions take pictures when the camera sees a smile (e.g., in response to smile recognition 120). For example, smile recognition is turned on at 218 (see FIG. 5), AV content is played at 220, and a photo or photos are captured 222 when a smile is detected while the AV content is playing.

Alternatively, or in addition, one or both versions take pictures when the camera recognizes a face (e.g., in response to facial recognition 118). For example, facial recognition is turned on at 224, AV content is played at 226, and a photo or photos are captured 228 when a face is recognized while the AV content is playing.

Alternatively, or in addition, the professional version provides the option to take photos manually with one of the hardware switches 16, 18, 20, or 22, such as by pushing the minus (−) button (e.g., the button which is also used to decrease volume or decrease the ringer) 14 on the side of the device 10 (see FIG. 2). This option is useful for users who want to take a photo at a certain time in the attention-getting audio or video playback to get the best effect or facial expressions while the person is watching the desired audio-visual content. For example, AV content is played at 230, and a photo or photos are captured (or video is started) 232 when a hardware switch is actuated or an area on the touch screen 36 is actuated. In the case of video, the video is stopped when the same or different switch or area on the touch screen 36 is actuated.

In various embodiments, the device 10 receives an input 201 or 203 from a user (e.g., via one or more menus or a settings screen) as to what AV content is to be played. Various options for content are available, in the illustrated embodiments. For example, a user can select AV content in (or provided with) the application 86 or played from elsewhere in the device 10 or from other sources. For example, the user may download attention-getting AV content to the device 10 (e.g., from a server provided by the vendor of the application 86) or from an app store (e.g. along with the application 86). In some embodiments, a user can browse directories or files on the device in the application 86 or outside the application 86 to select AV content to be played, or can input a link pointing to content in the device 10 or outside of the device 10 (e.g., on the Internet). As stated above, there may be more options available for selection of the AV source with the professional version 204 versus the basic version 202. The basic version 202 may include any desired subset of the possible ways to select AV content described herein, in some embodiments.

In various embodiments shown in FIG. 4, the device 10 receives an input from a user (e.g., via one or more menus or a settings screen) as to what In various embodiments shown in FIG. 4, the device 10 receives an input from a user (e.g., via one or more menus or a settings screen) as to what settings or mode of operation the user desires, in the professional version 204. Some settings may also be provided in the basic version, in various embodiments. If the user selected taking photos at intervals, at 236 operation of the application flows to 210 and 212. If the user selected taking photos at locations in the AV content, at 238 operation of the application flows to 214 and 216. If the user selected taking photos at locations in response to a smile, at 240 operation of the application flows to 224, 226, and 228. If the user selected taking photos at locations in response to facial recognition, at 242 operation of the application flows to 218, 220, and 222. If the user selected taking photos or videos manually, operation flows to 230 and 232.

In some embodiments, attention-getting audio or video files are provided with the application 86. In some embodiments, it is possible to play other content than content provided with the application 86. In some embodiments, the application 86 is able to play any of power point presentations, videos from Internet, and uploaded movies.

Thus, various embodiments provide a system and method to attract the attention of the subject of a photo or video (e.g., a child or children), at the desired moment to get a good picture. Some embodiments provide a system and method to modify the expression on the face of the subject by changing the audio-video content on the screen 36.

In various embodiments, the application 86 is used to monitor the response of people while watching a presentation of a project or other content to get feedback about the contents.

While certain functions are illustrated as being performed in certain blocks, it should be understood that various functions may be performed in other blocks or in a combination of blocks. The blocks do not necessarily correspond to integrated circuits or circuit blocks. Multiple blocks may be defined by a single integrated circuit or a single block may be defined by multiple integrated circuits.

While some embodiments disclosed herein are implemented in software, alternative embodiments comprise hardware, such as hardware including digital logic circuitry. Still other embodiments are implemented in a combination of software and digital logic circuitry.

Various embodiments comprise a computer-usable or computer-readable medium, such as a hard drive, solid state memory, flash drive, floppy disk, CD (read-only or rewritable), DVD (read-only or rewritable), tape, optical disk, floptical disk, RAM, ROM (or any other non-transitory medium capable of storing program code) bearing computer program code which, when executed by a portable multi-function device, by a computer, by a processor, or by a distributed processing system, performs various of the functions described above.

Some embodiments provide a carrier wave or propagation signal embodying such computer program code for transfer of such code over a network or from one device to another. The term “non-transitory,” if used in the claims, is meant to exclude only such a carrier wave or propagation signal.

In compliance with the patent laws, the subject matter disclosed herein has been described in language more or less specific as to structural and methodical features. However, the scope of protection sought is to be limited only by the following claims, given their broadest possible interpretations. The claims are not to be limited by the specific features shown and described, as the description above only discloses example embodiments.

I/We claim:

1. A method of attracting attention to a camera, the method comprising:
playing audio-visual content from a portable multi-function device having a housing having a first major side facing in a first direction and a second major side facing in a second direction different from the first direction, having a screen supported by the housing, the screen facing in the first direction, and the device having a camera facing the first direction; and
causing operation of the camera to capture at least one of a photograph and movie while the audio-visual content is playing.

2. A method in accordance with claim 1 wherein operation of the camera takes place at a predetermined time during playing of the audio-visual content.

3. A method in accordance with claim 1 wherein a photograph is captured at a user-programmable time during playing of the audio-visual content, the time being programmed prior to playing of the audio-visual content.

4. A method in accordance with claim 1 and comprising capturing photographs at a user-selected location during playing of the audio-visual content, the location being selected prior to playing of the audio-visual content.

5. A method in accordance with claim 1 wherein the device has a hardware switch and wherein operation of the camera occurs in response to a user actuating the hardware switch.

6. A method in accordance with claim 1 wherein the device is a smart phone.

7. A method in accordance with claim 1 wherein the device has a second camera facing the second direction.

8. A method in accordance with claim 1 and comprising capturing photographs at predetermined intervals during playing of the audio-visual content.

9. A method in accordance with claim 1 and comprising capturing a photograph in response to facial recognition occurring while the content is played.

10. A method in accordance with claim 1 and comprising capturing a photograph in response to smile recognition occurring while the content is played.

11. A computer readable medium bearing computer program code which, when executed by a portable multi-function device having a housing having a first major side facing in a first direction and a second major side facing in a second direction different from the first direction, having a screen supported by the housing and facing in the first direction, having a speaker, and having a camera facing the first direction, causes the device to:
play audio-visual content using the screen and the speaker; and
operate the camera to capture at least one of a photograph and movie, while the audio-visual content is played.

12. A portable multi-function device comprising:
a housing having a first major side facing in a first direction and a second major side facing in a second direction different from the first direction;
a touchscreen supported by the housing and facing in the first direction;
a speaker supported by the housing;
a first camera supported by the housing and facing the first direction;
a second camera supported by the housing and facing in the second direction;
a memory;
a processor coupled to the touchscreen, speaker, camera, and memory;
audio-visual content in the memory configured to elicit a reaction from a subject of a photograph;
an application in the memory configured to play the audio-visual content on the touchscreen and to capture a photograph, using the first camera, during playing of the audio-visual content.

13. A system in accordance with claim 12 wherein the application is configured to cause operation of the camera to capture a photograph at a predetermined time during playing of the audio-visual content.

14. A system in accordance with claim 12 wherein the application is configured to cause operation of the camera to capture a photograph at a user-programmable time during playing of the audio-visual content, the time being programmed prior to playing of the audio-visual content.

15. A system in accordance with claim 12 wherein the application is configured to cause the photograph to be captured at a user-programmable location during playing of the audio-visual content, the location being programmed by a user using the application, prior to playing of the audio-visual content.

16. A system in accordance with claim 12 and further comprising a hardware switch supported by the housing, and wherein the application causes operation of the camera in response to a user actuating the hardware switch.

17. A system in accordance with claim 12 wherein the application is configured to cause capturing of photographs at predetermined intervals during playing of the audio-visual content.

18. A system in accordance with claim 12 wherein the application is configured to cause capturing of a photograph in response to facial recognition occurring during playing of the audio-visual content.

19. A system in accordance with claim 12 wherein the application is configured to cause capturing a photograph in response to smile recognition occurring while the content is played.

20. A system in accordance with claim 12 and defining a smart phone.
